(19) United States
(12) Patent Application Publication
(10) Pub. No.: US 2023/0286485 A1
(43) Pub. Date: Sep. 14, 2023

(54) DRUM BRAKE AND ELECTRONIC PARKING BRAKE

(71) Applicant: HYUNDAI MOBIS Co., Ltd., Seoul (KR)

(72) Inventor: Dae Ung Jeon, Yongin-si (KR)

(73) Assignee: HYUNDAI MOBIS Co., Ltd., Seoul (KR)

(21) Appl. No.: 18/081,959

(22) Filed: Dec. 15, 2022

(30) Foreign Application Priority Data
Mar. 11, 2022 (KR) 10-2022-0030860

(51) Int. Cl. B60T 13/74; F16D 65/22; B60T 1/06

(52) U.S. Cl. CPC B60T 13/746; B60T 1/067; F16D 65/22; F16D 2121/24

(57) ABSTRACT

The present disclosure relates to a drum brake. The drum brake includes a bolt screw being rotated in conjunction with drive of a first motor, a nut piston being combined by a bolt-nut fastening with a circumference of the bolt screw and being moved toward a direction in which the nut piston presses against a shoe, in conjunction of the rotation of the bolt screw, and a press nut being combined by the bolt-nut fastening with a circumference of the nut piston, being moved toward an axial direction in conjunction with drive of a second motor, being brought into contact with the bolt screw, and thus preventing the nut piston from being pushed due to a reaction force of the shoe.

### CROSS-REFERENCE TO RELATED APPLICATION

This application claims priority from and the benefit of Korean Patent Application No. 10-2022-0030860, filed on Mar. 11, 2022, which is hereby incorporated by reference for all purposes as if set forth herein.

### BACKGROUND

### Field

The present disclosure relates to a drum brake and an electronic parking brake and, more particularly, to a drum brake and an electronic parking brake that are capable of keep a vehicle at a stop, using an actuator.

### Discussion of the Background

Usually, a service brake serves to reduce a traveling speed of a vehicle or to suddenly stop the vehicle, and a parking brake serves to park the vehicle or to keep the vehicle at a stop. A drum brake is a device that makes the vehicle slow down or stop by causing friction with a drum that is rotated together with a wheel. The drum brake is arranged on a backplate in a such a manner as to face an inner circumferential surface of the drum. The drum brake presses against a pair of shoes to which a friction material is attached, toward the drum and thus causes the friction with the drum, thereby generating a braking force for service braking and braking for parking.

An electro-mechanical brake (hereinafter referred to as “EMB”) is a brake device that uses a force to which a boost is provided by a motor, a gear, and a screw. An electronic control unit (hereinafter referred to as “ECU”) converts pressure of a brake pedal depressed by a driver into an electric signal. The EMB exerts a braking force corresponding to the electric signal. An electronic parking brake (hereinafter referred to as “EPB”) is a brake device that operates electronically. When the vehicle stops traveling, the ECU measures a vehicle speed and engine rotation and detects a braking operation or the like and thus operates an operation of holding a brake.

In order to perform service parking, the vehicle has to be automatically kept out of a braking state after the EMB starts to operate. A screw that is used for the EMB is required not to be self-locked. In order to satisfy the requirement that the screw should not be self-locked, a high-lead screw or a ball-screw that has an increased lead or an increased number of starts has to be used. In contrast, in order to perform the braking for parking, the brake state has to be maintained after the EPB starts to operate. Therefore, a screw that is used for the EPB has to be capable of being self-locked. In this manner, characteristics of the screw that is required for the service braking are different from characteristics of the screw that are required for the braking for parking.

A drum brake in the related art has a structure in which a screw for service braking and a screw for braking for parking are separated provided, and has a structure in which a component for boosting a force of the screw for the service braking and a component for boosting a force of the screw for the braking for parking are separately provided. According, there occurs a problem in that the number of components is increased, a layout is complicated, and thus the manufacturing cost is increased.

Therefore, there is a need to solve this problem.

The background art of the present disclosure is disclosed in Korean Patent No. 2288508 (registered on Aug. 4, 2021 and entitled “Electronic Parking Brake”

### SUMMARY

An object of the present disclosure is to provide a drum brake and an electronic parking brake that are capable of employing a simple structure in which a service brake and a parking brake share one screw.

According to an aspect of the present disclosure, there is provided a drum brake including: a bolt screw being configured to be rotatable in conjunction with drive of a first motor; a nut piston being combined by bolt-nut fastening with a circumference of the bolt screw and being configured to be movable toward a direction in which the nut piston presses against a shoe, in conjunction of the rotation of the bolt screw; and a press nut being combined by the bolt-nut fastening with a circumference of the nut piston, being configured to be movable toward an axial direction in conjunction with drive of a second motor, and being configured to be brought into contact with the bolt screw to prevent the nut piston from being pushed due to a reaction force of the shoe.

In the drum brake, the first motor, the bolt screw, and the nut piston may be components of a service brake for reducing a traveling speed of a vehicle or for suddenly stopping the vehicle, the second motor and the press nut may be components of a parking brake for parking the vehicle or for keeping the vehicle at a stop, and the press nut and the bolt screw may be spaced in the axial direction away from each other in a state where the nut piston presses against the shoe due to the drive of the first motor, and the press nut may be configured to be movable toward the bolt screw due to the drive of the second motor to be brought into contact with the bolt screw.

In the drum brake, an inner circumferential portion of the nut piston and an outer circumferential portion of the bolt screw may have a screw structure in which, in a state where the nut piston presses against the shoe, when the first motor stops being driven, the nut piston is not self-locked in response to the reaction force of the shoe, and an inner circumferential portion of the press nut and an outer circumferential portion of the nut piston may have a screw structure in which, in a state where the press nut is brought into contact with the bolt screw toward the axial direction, when the second motor stops being driven, the nut piston is self-locked in response to the reaction force of the shoe.

In the drum brake, the first motor, the bolt screw, and the nut piston may be components of a service brake for reducing a traveling speed of a vehicle or for suddenly stopping the vehicle, the service brake may further include a first motive power transfer apparatus transferring a rotational force of the first motor to the bolt screw, wherein the first motive power transfer apparatus may include: a drive gear being supplied with motive power from the first motor, thereby being rotated; and a driven gear being engaged with the drive gear, thereby being rotated at a reduced speed, and being coaxially combined with the bolt screw.

In the drum brake, the bolt screw may include: a gear assembly portion having a polygonal cross section, being installed in a manner that passes through a screw combination hole in the driven gear, and being configured to be slidably movable along the screw combination hole toward the axial direction; and a screw extension portion being coaxially continuous with the gear assembly portion and being combined by the bolt-nut fastening with the nut piston.

In the drum brake, the screw extension portion may have a smaller diameter than the gear assembly portion, and the press nut may be arranged in a manner that faces a first-side lateral-surface portion in the axial direction of the gear assembly portion.

In the drum brake, the bolt screw may include: a gear assembly portion being supplied with a rotational force from the first motor; a screw extension portion being coaxially continuous with the gear assembly portion and being combined by the bolt-nut fastening with the nut piston; and a press contact portion being arranged on the gear assembly portion or the screw extension portion in a manner that faces the press nut in the axial direction, and being brought into contact with the press nut.

In the drum brake, the bolt screw may include: a gear assembly portion being supplied with a rotational force from the first motor; a screw extension portion being combined by the bolt-nut fastening with the nut piston; a fixation portion being disposed between the gear assembly portion and the screw extension portion and being coaxially continuous with the gear assembly portion and the screw extension portion; a press plate being fixed to the fixation portion and being arranged in a manner that protrudes farther toward a radial direction than the screw extension portion; and a press contact portion being arranged on the press plate in a manner that faces the press nut in the axial direction and being brought into contract with the press nut.

In the drum brake, the gear assembly portion may have a smaller diameter than the screw extension portion, and the press nut may be arranged in a manner that faces a first-side lateral-surface portion in the axial direction of the press plate.

In the drum brake, the fixation portion may be externally threaded, and the press plate may be fixed by combining an internally-tapped ring member with the fixation portion by the bolt-nut fastening.

In the drum brake, the second motor and the press nut may be components of a parking brake for parking a vehicle or for keeping the vehicle at a stop, the parking brake may further include a second motive power transfer apparatus transferring a rotational force of the second motor to the press nut, and the second motive power transfer apparatus may include: a first gear being connected to the second motor; and a second gear of which a first-side portion is engaged with the first gear to be rotatable at a reduced speed and of which a second-side portion is engaged with the press nut.

In the drum brake, the press nut that has a greater diameter than the second gear, may be engaged with the second gear and may have such a length in the axial direction that the press unit is movable in a manner that is brought into contact with or spaced from the bolt screw, while kept engaged with the second gear.

The drum brake may further include a housing having one communicating space in which the bolt screw, the nut piston, and the press nut are accommodated, wherein the housing may include: a first housing unit in which one portion of a service brake is accommodated; a second housing unit in which one portion of a parking brake is accommodated; and a combination cylinder unit having a shape of a hollow cylinder in a portion where the first housing unit and the second housing unit are combined with each other, and accommodating the bolt screw, the nut piston, and the press nut.

In the drum brake, the second housing unit may include: a motor accommodation unit accommodating the second motor; a gear accommodation unit accommodating a second motive power transfer apparatus transferring a rotational force of the second motor to the press nut; and a piston accommodation unit whose one end portion facing the first housing unit is combined with the first housing unit, thereby forming the combination cylinder unit, and on whose other portion facing the shoe the nut piston is installed by passing therethrough, the piston accommodation unit being configured to communicate with the gear accommodation unit.

According to another aspect of the present disclosure, there is provided an electronic parking brake include: a second motor; a press nut being combined by bolt-nut fastening with a circumference of a nut piston of a service brake that presses against a shoe, being configured to be movable toward an axial direction in conjunction with drive of the second motor, and being configured to be brought into contact with a bolt screw combined by the bolt-nut fastening with the nut piston to prevent the nut piston from being pushed due to a reaction force of the shoe; and a second motive power transfer apparatus transferring a rotational force of the second motor to the press nut.

In the electronic parking brake, the press nut may include: a nut main body being arranged on a circumference of the nut piston; a screw combination portion being disposed on an inner circumferential portion of the nut main body and being combined by the bolt-nut fastening with the nut piston; a gear-teeth portion being formed on an outer circumferential portion of the nut main body and being supplied with the rotational force from the second motor; and a screw attachment-detachment portion being disposed on an end portion of the nut main body and being configured to be brought into contact with the bolt screw toward the axial direction when the nut main body is moved.

In the electronic parking brake, the screw attachment-detachment portion may include: a limitation jaw being disposed on an end portion in the axial direction of the nut main body in a manner that protrudes inward toward a direction of an axial center, and being arranged in a manner that faces the nut piston positioned inside the nut main body, in the axial direction; and a screw contact portion being disposed on the limitation jaw in a manner that protrudes toward the axial direction, and facing the bolt screw in the axial direction and being in contact therewith.

In the electronic parking brake, inner circumferential portions of the limitation jaw and the screw contact portion may each have a greater diameter than the bolt screw and may be spaced away from a circumference of the bolt screw, and motive power that is transferred from the second motor to the nut main body may serve as a load that is exerted on the bolt screw toward the axial direction through the screw contact portion.

In the electronic parking brake, when the second motor is driven in a forward direction, the press nut may be movable to one side toward the axial direction up to a position where the screw contact portion is pressed against and brought into contact with the bolt screw toward the axial direction, and when the second motor is driven in a reverse direction, the press nut may be movable to the other side toward the axial direction up to a position where the limitation jaw is brought into contact with the nut piston toward the axial direction.

In the electronic parking brake, at least one portion of the second motor may be accommodated together in a housing in which the bolt screw, the nut piston, and the press nut are accommodated, and may be arranged on one side of a plate surface of a backplate in a manner that is in parallel with the bolt screw, the nut piston, and the press nut.

The drum brake according to the present disclosure has a structure in which the service brake and the parking brake are coaxially combined with each other. More particularly, according to the present disclosure, the drum brake has a structure in which the bolt screw and the nut piston of the service brake and the press nut of the parking brake are coaxially combined by the bolt-nut fastening with each other. In other words, the parking brake according to the present disclosure has a simple structure in which the press nut is additionally combined by the bolt-nut fastening with the circumference of the nut piston provided in the service brake. That is, according to the present disclosure, the drum brake has a simple structure in which the service brake and the parking brake share one screw corresponding to the bolt screw.

Accordingly, the above-mentioned structures according to the present disclosure provide the following advantages, when compared with the case where the service brake and the parking brake in the related art are arranged independently of each other, in other words, when compared with the case where the service brake and the parking brake in the related art are arranged in such a manner as to be spaced away from each other and thus to be separated from each other. The numbers of components of, and volumetric weights, of the service brake and the parking brake can be remarkably reduced, and space utilization and the freedom of layout design can be further improved. Moreover, the manufacturing cost and the productivity can be improved.

In addition, the braking for parking is performed by pressing against the bolt screw using the press nut and thus preventing the nut piston from being rotated. Accordingly, when compared with the parking brake in the related art in which the shoe is directly pressed against, the braking for parking can be stably performed by outputting a remarkably low load. Accordingly, the motor, the motive power transfer apparatus, and the housing can be size-reduced and weight-reduced.

### BRIEF DESCRIPTION OF THE DRAWINGS

FIG. 1 is a perspective view schematically illustrating a drum brake according to a first embodiment of the present disclosure.

FIG. 2 is a perspective view illustrating essential constituent elements of the drum brake in FIG. 1.

FIG. 3 is a cross-sectional view illustrating the essential constituent elements of the drum brake in FIG. 1.

FIG. 4 is a perspective view illustrating other essential constituent elements of the drum brake in FIG. 1.

FIG. 5 is an exploded perspective view illustrating the other essential constituent elements of the drum brake in FIG. 1.

FIG. 6 is an operational view illustrating a state where brake is performed by a service brake according to the first embodiment of the present disclosure.

FIG. 7 is an operational view illustrating a state where the brake is performed by a parking brake according to the first embodiment of the present disclosure.

FIG. 8 is a cross-sectional view schematically illustrating essential constituent elements of a drum brake according to a second embodiment of the present disclosure.

FIG. 9 is a perspective view schematically illustrating the essential constituent elements of the drum brake according to the second embodiment of the present disclosure.

FIG. 10 is an exploded perspective view schematically illustrating the essential constituent elements of the drum brake according to the second embodiment of the present disclosure.

FIG. 11 is an operational view illustrating a state where the brake is performed by a service brake according to the second embodiment of the present disclosure.

FIG. 12 is an operational view illustrating a state where the brake is performed by a parking brake according to the second embodiment of the present disclosure.

### DETAILED DESCRIPTION OF THE ILLUSTRATED EMBODIMENTS

A drum brake and an electronic parking brake according to embodiments of the present disclosure will be described below with reference to the accompanying drawings. For clarity and convenience in description, thicknesses of lines, sizes of constituent elements, and the like may be illustrated in non-exact proportion in the drawings. In addition, a term to be assigned to a constituent element according to the present disclosure is defined considering a function of the constituent element and may vary according to a user’s intention or a manager’s intention or based on practices in the art. Therefore, the term should be defined in context in light of the present specification.

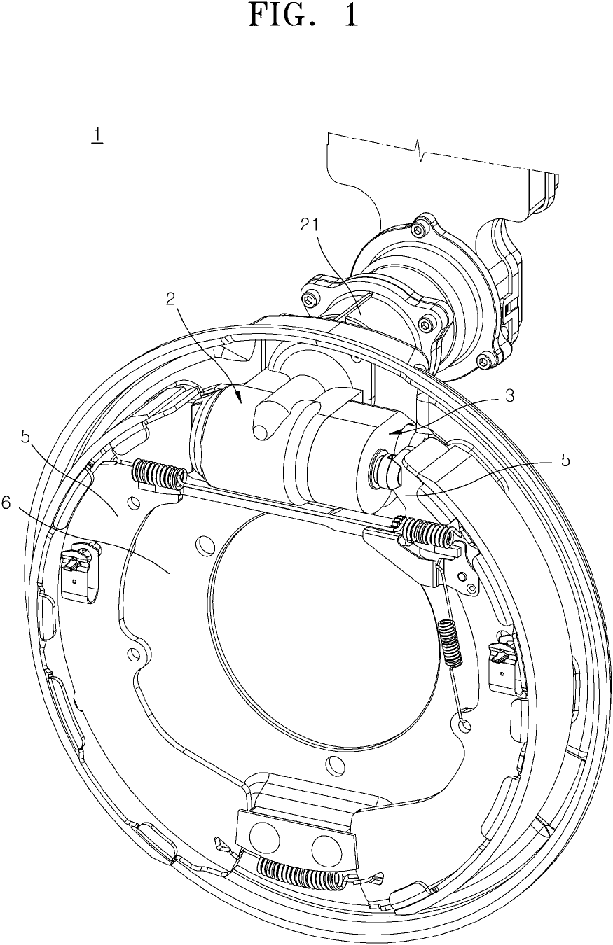

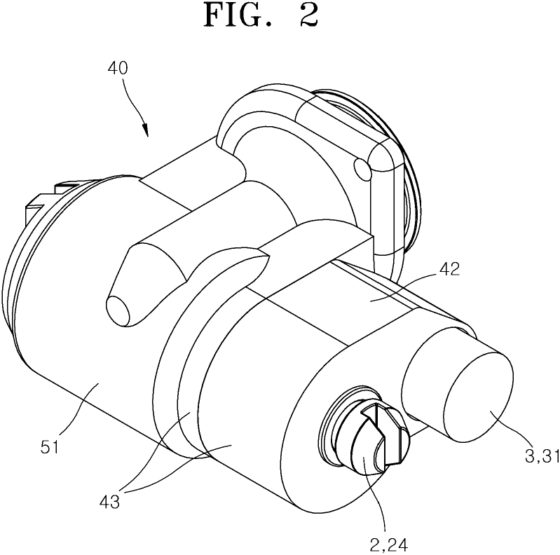

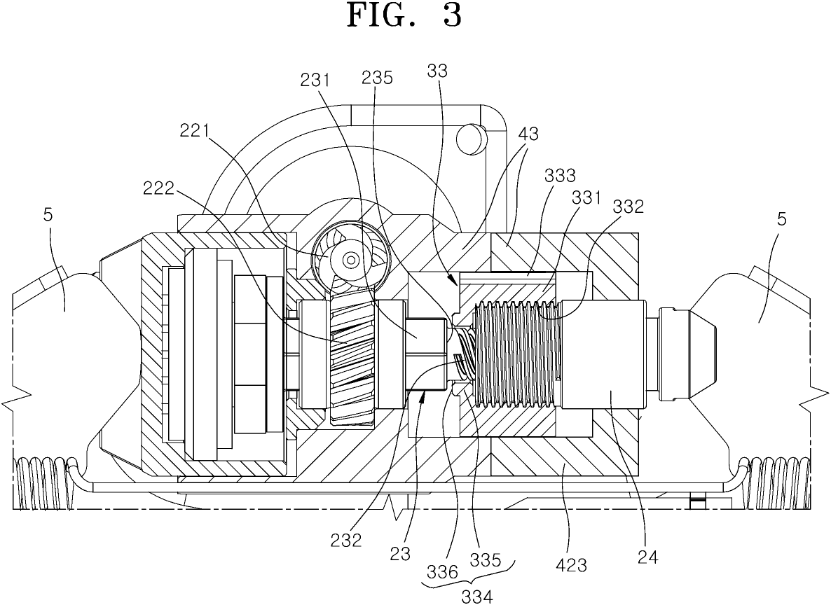

FIG. 1 is a perspective view schematically illustrating a drum brake 1 according to a first embodiment of the present disclosure. FIG. 2 is a perspective view illustrating essential constituent elements of the drum brake in FIG. 1. FIG. 3 is a cross-sectional view illustrating the essential constituent elements of the drum brake in FIG. 1.

With reference to FIGS. 1 to 3, the drum brake 1 according to the first embodiment of the present disclosure has a configuration in which a service brake 2 for reducing a traveling speed of a vehicle or for suddenly stopping the vehicle and a parking brake 3 for parking the vehicle or for keeping the vehicle at a stop share one screw member corresponding to a bolt screw 23 and are arranged in one communicating space.

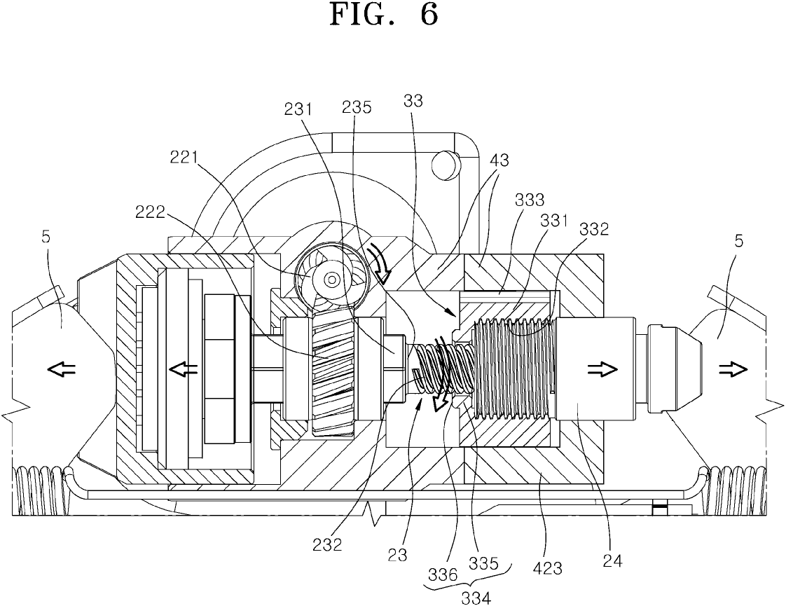

The service brake 2 according to the first embodiment of the present disclosure performs an operation of pressing against and pushing a shoe 5 by rotating the bolt screw 23 in conjunction with drive of a first motor 21 and moving toward an axial direction a nut piston 24 combined by bolt-nut fastening with a circumference of the bolt screw 23 (refer to FIG. 6).

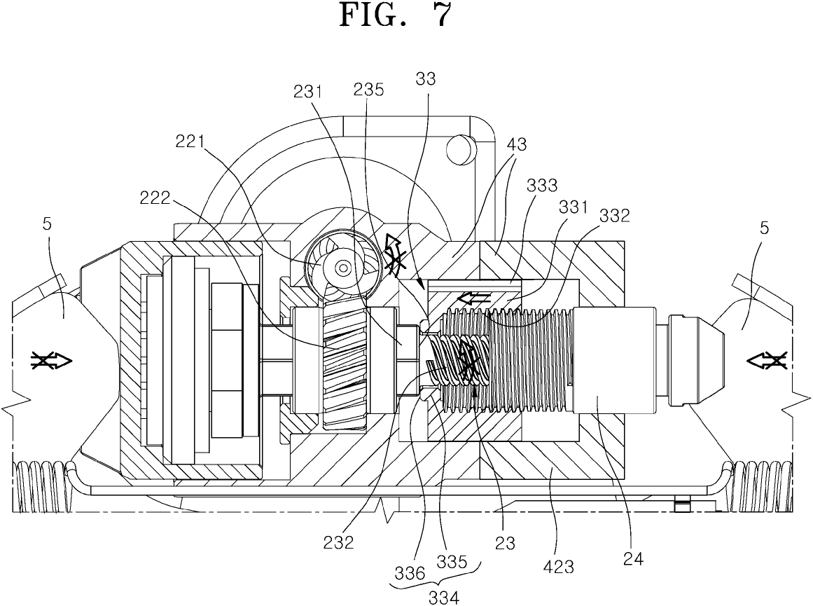

The parking brake 3 according to the first embodiment of the present disclosure is combined by the bolt-nut fastening with a circumference of the nut piston 24 in a manner that overlaps a press nut 33, and performs an operation of preventing the nut piston 24 from being pushed in the opposite direction due to a reaction force of the shoe 5, by moving the press nut 33 toward the axial direction in conjunction with drive of a second motor 31 and thus pressing against the press nut 33 toward the axial direction and thus bringing the press nut 33 into contact with the bolt screw 23 (refer to FIG. 7).

In FIG. 3, the bolt screw 23 is arranged in a manner that extends in a transverse direction. For convenience, the transverse direction is hereinafter defined as the axial direction or a leftward-rightward direction. A positional relationship and a combination relationship among constituent elements will be described below according to this definition. A portion of the bolt screw 23 that is brought into contact with the press nut 33 toward the axial direction is referred to as a press contact portion 235 throughout the present specification.

The press nut 33 is positioned between the press contact portion 235 on the left side of FIG. 3 and the nut piston 24 on the right side thereof. A portion of the left side of the press nut 33 is removably attached to the press contact portion 235 according to a position in the axial direction of the press nut 33. Although the position in the axial direction of the press nut 33 varies, a portion of the right side of the press nut 33 is always kept combined by the bolt-nut fastening with the circumference of the nut piston 24.

The press nut 33 is moved in the axial direction while remaining engaged with the nut piston 24. Then, when the press nut 33 comes into contact with the press contact portion 235 of the bolt screw 23, a pressing force to the right is additionally applied to the nut piston 24, and a pressing force to the left is additionally applied to the bolt screw 23 by the press nut 33. Accordingly, it is possible to prevent the nut piston 24 from being pushed toward the press contact portion 235 by the reaction force of the shoe 5.

According to the first embodiment of the present disclosure, as described above, braking for parking may be performed by moving the press nut 33 with the drive of the second motor 31 in a state where the nut piston 24 presses against the shoe 5 with the drive of the first motor 21. At this point, at least with a load high enough to restrict rotation (return to a waiting position illustrated in FIG. 3) of the nut piston 24, the press nut 33 needs to be brought into contact with the press contact portion 235.

The parking brake 3 in the related art is separately provided independently of the service brake 2 and configured to directly press against the shoe 5. Accordingly, in the related art, the second motor 31, a second motive power transfer apparatus 32, and the like are required to finally output a load of 1200 to 1400 kg. However, according to the present disclosure, the braking for parking may be stably performed by outputting a remarkably low load of 10 to 20 kg.

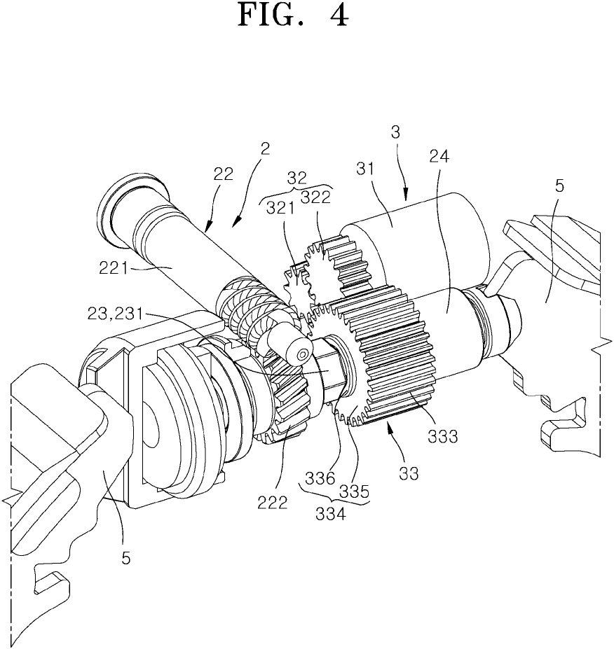

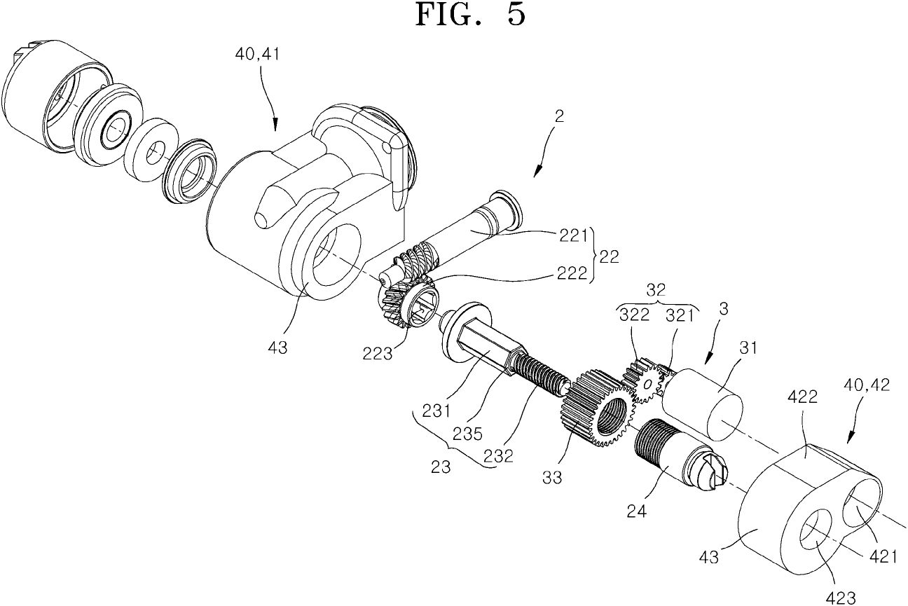

FIG. 4 is a perspective view illustrating other essential constituent elements of the brake drum in FIG. 1. FIG. 5 is an exploded perspective view illustrating the other essential constituent elements of the brake drum in FIG. 1.

With reference to FIGS. 3 to 5, the service brake 2 according to the first embodiment of the present disclosure includes the first motor 21, a first motive power transfer apparatus 22, the bolt screw 23, and the nut piston 24.

With reference to FIG. 1, the bolt screw 23 and the nut piston 24 are arranged in front of a backplate 6 (on one side of a plate surface thereof), and the first motor 21 is arranged behind the backplate 6 (on the other side of the plate surface thereof). The first motive power transfer apparatus 22 is arranged on the backplate 6 in a manner that passes therethrough and transfers a rotational force of the first motor 21 that is arranged behind the backplate 6, to the bolt screw 23 in front of the backplate 6. The first motive power transfer apparatus 22 according to the first embodiment of the present disclosure includes a drive gear 221 and a driven gear 222.

The drive gear 221 is a gear member that is connected to an output shaft of the first motor 21. The drive gear 221 has a worm gear structure and is supplied with a motive power from the first motor 21, thereby being rotated at a regular position thereof. The driven gear 222 is a gear member that transfers a rotational force of the drive gear 221 to the bolt screw 23. The driven gear 222 has a wheel gear structure, is installed in a manner that is engaged with the drive gear 221, and is rotated at a reduced speed at a regular position thereof.

A screw combination hole 223 is formed in the driven gear 222. The bolt screw 23 is combined with the screw combination hole 223 by passing therethrough. The bolt screw 23 is installed in the screw combination hole 223 by passing therethrough toward the axial direction. When the first motor 21 is driven, the bolt screw 23 is rotated by the same rotational displacement as the driven gear 222. The bolt screw 23 according to the first embodiment of the present disclosure includes a gear assembly portion 231, a screw extension portion 232, and the press contact portion 235.

The gear assembly portion 231 is a portion of the bolt screw 23 that is supplied with a rotational force from the first motor 21 through the first motive power transfer apparatus 22. The gear assembly portion 231 is installed in a manner that passes through the screw combination hole 223 in the driven gear 222 toward the axial direction and has a cross section with a fixed shape with respect to the axial direction. Accordingly, the bolt screw 23 is slidably movable toward the axial direction in a state of being guided by an edge portion of the screw combination hole 223.

In addition, the gear assembly portion 231 and the screw combination hole 223 each have a cross section having a shape other than a circle, for example, have a polygonal cross section. Accordingly, when the driven gear 222 is rotated, the bolt screw 23 may be stably rotated by the same rotational displacement as the driven gear 222.

The screw extension portion 232 is a portion of the bolt screw 23 that is combined by the bolt-nut fastening with the nut piston 24. The screw extension portion 232 is formed in a manner that is coaxially continuous with the gear assembly portion 231. A circumference of the screw extension portion 232 is externally threaded in such a manner that the nut piston 24 may be combined by the bolt-nut fastening with the screw extension portion 232. The externally threaded screw extension portion 232 according to the first embodiment of the present disclosure has a tap-screw structure.

The screw extension portion 232 has a smaller diameter than the gear assembly portion 231. The screw extension portion 232 has a circular cross section while the gear assembly portion 231 has a cross section, as a whole, that has a shape other than a circle. Accordingly, a right-side lateral-surface portion of the gear assembly portion 231 that is positioned at a border between the gear assembly 231 and the screw extension portion 232 has a shape of a hooking jaw.

The gear assembly portion 231 is arranged in such a manner that the right-side lateral-surface portion thereof faces a left-side lateral-surface portion of the press nut 33 combined by the bolt-nut fastening with the circumference of the nut piston 24, in the axial direction, and, when the press nut 33 is moved to the left, the surface portion of the right side thereof is pressed against and brought into contact with the press nut 33. That is, the right-side lateral-surface portion of the gear assembly portion 231 that is shaped in such a manner as to protrude farther toward a radial direction than the screw extension portion 232 is the press contact portion 235 to which the press nut 33 is removably attached.

The nut piston 24 is combined by the bolt-nut fastening with the circumference of the bolt screw 23, and is moved toward the axial direction (in the rightward direction) in conjunction with rotation of the bolt screw 23, thereby pressing against and pushing the shoe 5. The nut piston 24 has a screw structure in which the nut piston 24 is not self-locked in response to the reaction force of the shoe 5 when the first motor 21 stops being driven in a state where the nut piston 24 presses against the shoe 5. An end portion of the nut piston 24 that is brought into contact with the shoe 5 has such a shape of tongs that the end portion thereof faces front and rear surface portions of the shoe 5 and then is brought into contact therewith. Accordingly, the nut piston 24 has only displacement in the axial direction without being rotated.

When the nut piston 24 is described as not being self-locked throughout the present specification, this means the following: In a state where the bolt screw 23 is rotated in a forward direction in conjunction with the drive of the first motor 21 and where the nut piston 24 is moved to the right, thereby pressing against and pushing the shoe 5, when the first motor 21 stops being driven, that is, when pressing for service braking of the vehicle is no longer performed, the nut piston 24 is pushed by itself to the left due to the reaction force of the shoe 5 that is exerted on the nut piston 24. At this point, the nut piston 24 has only a linear movement displacement in the axial direction, and thus the bolt screw 23 is rotated in a reverse direction.

Various factors, such as a lead angle of a threaded surface, a lead, the number of starts, a type of screw, a material, and surface roughness, may be comprehensively considered in realizing in this manner the screw structure in which the nut piston 24 is not self-locked. For example, the larger the lead angle of the threaded surface, the smaller force may be exerted for rotation with respect to a load in the axial direction. That is, the larger the lead angle, the more easily the nut piston 24 may be pushed due to the reaction force of the shoe 5. Thus, the structure in which the nut piston 24 is not self-locked may be easily realized.

The service brake 2 according to the first embodiment of the present disclosure is described above for disclosing the service brake 2 according to a preferred embodiment of the present disclosure and is not intended to specifically limit a structure of the service brake 2 according to the present disclosure. The service brake 2 according to the present disclosure is not limited to specific structures and shapes that include those in the related art, as long as it has a configuration in which, in conjunction with the drive of the first motor 21, the bolt screw 23 is rotated and the nut piston 24 is moved toward the axial direction.

With reference to FIGS. 3 to 5, the parking brake 3 according to the first embodiment of the present disclosure includes the second motor 31, the second motive power transfer apparatus 32, and the press nut 33.

The second motor 31 may be provided separately from the first motor 21 and may be arranged in front of the backplate 6 (on one side of the plate surface) in a manner that is in parallel with the bolt screw 23 and the nut piston 24. The second motor 31 may be arranged behind the backplate 6, together with the first motor 21. However, the more miniaturized the second motor 31, the more easily the second motor 31 may be arranged in front of the backplate 6, together with the second motive power transfer apparatus 32.

The second motor 31, when intended to be arranged in front of the backplate 6, is arranged in a state where one portion or all portions thereof are accommodated in a housing 40 having one communicating space in which the bolt screw 23, the nut piston 24, and the press nut 33 are accommodated. The second motor 31 may be arranged in a second housing unit 42 (described below) of the housing 40, and thus may be parallelly arranged in front of the backplate 6, together with the bolt screw 23, the nut piston 24, and the press nut 33.

In a case where the second motor 31 is arranged in front of the backplate 6, there is no need to form a through-hole in the backplate 6 in order to transfer an output of the second motor 31 to the press nut 33. Thus, the overall structural rigidity of an apparatus including the backplate 6 may be secured more stably. In addition, because the second motor 31 is positioned closer to the press nut 33, the motive power may be transferred more efficiently, and the second motive power transfer apparatus 32 may also be miniaturized.

The second motive power transfer apparatus 32 transfers a rotational force of the second motor 31 to the press nut 33. The second motive power transfer apparatus 32 according to the first embodiment of the present disclosure includes a first gear 321 and a second gear 322.

The first gear 321 is a gear member that is connected to an output shaft of the second motor 31. The second gear 322 is a speed-reduction gear member that transfers a rotational force of the first gear 321 to the press nut 33. The second gear 322 has a greater diameter than the first gear 321 and is engaged with the first gear 321. A first-side portion of a circumference of the second gear 322 on which gear teeth are formed is engaged with the first gear 321, and a second-side portion thereof is engaged with an outer circumferential portion of the press nut 33, more specifically, with a gear-teeth portion 333 (described below) of the press nut 33.

The press nut 33 has a greater diameter than the second gear 322. The press nut 33 is combined by the bolt-nut fastening with the circumference of the nut piston 24 and is engaged with the second gear 322. The screw extension portion 232 of the bolt screw 23 has a smaller diameter than the gear assembly portion 231. The press nut 33 is moved toward the axial direction in conjunction with the drive of the second motor 31, and thus is brought into contact with or spaced away from the bolt screw 23 in the axial direction.

More specifically, the press nut 33 is arranged on the same axis as the screw extension portion 232, but in a manner that faces a first-side lateral-surface portion in the axial direction of the gear assembly portion 231. In a state of being brought into contact with the bolt screw 23 toward the axial direction, the press nut 33 prevents the nut piston 24 from being pushed due to the reaction force of the shoe 5. The press nut 33 according to the first embodiment of the present disclosure includes a nut main body 331, a screw combination portion 332, the gear-teeth portion 333, and a screw attachment-detachment portion 334.

The nut main body 331 is a portion of the press nut 33 that constitutes a main body of the press nut 33. The nut main body 331 has the shape of a tube, a pipe, or a ring that has inner and outer circumferential portions, and is arranged on the circumference of the nut piston 24. The nut main body 331 maintains a state where the screw combination portion 332 is combined by the bolt-nut fastening with the nut piston 24 and where the gear-teeth portion 333 is engaged with the second gear 322, and has such a length in the axial direction that the screw attachment-detachment portion 334 is movable in a manner that is brought into contact with or spaced away from the bolt screw 23.

The screw combination portion 332 is a portion of the press nut 33 that is combined by the bolt-nut fastening with the circumference of the nut piston 24. The screw combination portion 332 is formed, in the shape of an internally tapped portion, on the inner circumferential portion of the nut main body 331. At this time, the screw combination portion 332 has the screw structure in which the nut piston 24 is self-locked in response to the reaction force of the shoe 5.

In a state where the traveling speed of the vehicle is reduced or where the shoe 5 is pressed against in order to suddenly stop the vehicle, that is, in a service braking state, the nut piston 24 has a structure in which the nut piston 24 is not self-locked in response to the reaction force of the shoe 5 when the first motor 21 stops being driven, for example, has such a high lead angle that the nut piston 24 is not self-locked. With this structure, the nut piston 24 is combined by the bolt-nut fastening with the bolt screw 23.

In contrast, in a state of being pressed against and brought into contact with the bolt screw 23 toward the axial direction in order to park the vehicle or keep the vehicle at a stop, that is, in a parking brake state, the press nut 33 has the structure in which the nut piston 24 is self-locked in response to the reaction force of the shoe 5 when the second motor 31 stops being driven. With this structure, the press nut 33 is combined by the bolt-nut fastening with the nut piston 24.

That is, the screw combination portion 332 of the press nut 33 is combined by the bolt-nut fastening with the nut piston 24, with the screw structure in which, when rotated, the press nut 33 is moved along the nut piston 24 toward the axial direction, but when the nut piston 24 is pressed against toward the axial direction, the press nut 33 may be kept stationary without being rotated, for example, with such a lower lead angle that the nut piston 24 may be self-locked.

The gear-teeth portion 333 is a portion of the press nut 33 that is supplied with a rotational force from the second motor 31. The gear-teeth portion 333 is formed on the outer circumferential portion of the nut main body 331. In a case where the first gear 321 and the second gear 322 have a spur-gear structure, the gear-teeth portion 333 may have a corresponding spur-gear structure. This gear is not specifically limited in structure and type. In addition to the spur-gear structure, any structure in which the rotational force may be transferred may be employed.

The screw attachment-detachment portion 334 is formed on an end portion in the axial direction (an end portion of the left side of FIG. 3) of the nut main body 331. When the nut main body 331 is moved to the left, the screw attachment-detachment portion 334 is brought into contact with the bolt screw 23 toward the axial direction. The screw attachment-detachment portion 334 according to the first embodiment of the present disclosure includes a limitation jaw 335 and a screw contact portion 336.

The limitation jaw 335 is formed on an end portion in the axial direction (an end portion on the left side of FIG. 3) of the nut main body 331 in a manner that protrudes inward toward a direction of the axial center. The limitation jaw 335 is arranged in a manner that faces an end portion of the left side of the nut piston 24 arranged inside the nut main body 331, in the axial direction (in the leftward-rightward direction in FIG. 3), and sets a limit to which the press nut 33 is moved to the right with respect to the nut piston 24.

The limitation jaw 335 is formed in a manner that protrudes inward in the direction of the axial center, but protrudes up to a position that is spaced away from the bolt screw 23 without being brought into contact therewith. In other words, in a case where the limitation jaw 335 has the shape of a circle as a whole, the limitation jaw 335 has an inner circumferential portion that has a greater diameter (width) than the screw extension portion 232 of the bolt screw 23. That is, the limitation jaw 335 is kept spaced away from the circumference of the bolt screw 23.

The screw contact portion 336 is formed on the limitation jaw 335 in a manner that protrudes therefrom toward the axial direction, more particularly, toward the gear assembly portion 231 and the press contact portion 235 (to the left in FIG. 3). The screw contact portion 336 is formed at a position on the limitation jaw 335 that faces the press contact portion 235, in a manner that protrudes therefrom. An inner circumferential portion of the screw contact portion 336 is spaced away from the circumference of the bolt screw 23.

More specifically, the press contact portion 235 is formed in the shape of a ring in such a manner as to have a width in the radial direction that corresponds to a difference in diameter between the gear assembly portion 231 and the screw extension portion 232, and the screw contact portion 336 has a ring-shaped cross section in such a manner as to face the press contact portion 235. Accordingly, when the press nut 33 is moved to the left, with the screw contact portion 336, the press nut 33 may be precisely pressed against and brought into contact with the press contact portion 235. Motive power that is transferred from the second motor 31 to the press nut 33 finally serves as a load that is exerted on the press contact portion 235 of the bolt screw 23 toward the axial direction through the screw contact portion 336.

When the second motor 31 is driven in the forward direction, the press nut 33 may be maximally moved toward the leftward direction up to a position where the screw contact portion 336 is pressed against and brought into contact with the bolt screw 23 toward the axial direction. When the second motor 31 is driven in the reverse direction, the press nut 33 may be maximally moved toward the rightward direction up to a position where the limitation jaw 335 is brought into contact with the nut piston 24 toward the axial direction.

The drum brake 1 according to the first embodiment of the present disclosure has a configuration in which the service brake 2 and the parking brake 3 shares one screw member corresponding to the bolt screw 23 and are arranged in one communicating space. With reference to FIGS. 1 to 3, the drum brake 1 according to the first embodiment of the present disclosure may include the housing 40 as a constituent element that constitutes this one communication space.

The housing 40 has a structure in which the bolt screw 23, the nut piston 24, and the press nut 33 are possibly accommodated in one communicating space. The housing 40 according to the first embodiment of the present disclosure includes a first housing unit 41, the second housing unit 42, and a combination cylinder unit 43.

The first housing unit 41 has a structure in which the service brake 2 is possible accommodated. The second housing unit 42 has a structure in which the parking brake 3 is possibly accommodated. The combination cylinder unit 43 is a portion of the housing 40 in which the bolt screw 23, the nut piston 24, and the press nut 33 are accommodated. The combination cylinder unit 43 is formed, in the shape of a hollow cylinder, in a portion where the first housing unit 41 and the second housing unit 42 are combined with each other.

A portion (one portion or all portions) other than a portion of the service brake 2 that is accommodated in the combination cylinder unit 43 may be accommodated in the first housing unit 41. A portion other than a portion of the parking brake 3 that is accommodated in the combination cylinder unit 43 may be accommodated in the second housing unit 42. The second housing unit 42 according to the first embodiment of the present disclosure includes a motor accommodation unit 421, a gear accommodation unit 422, and a piston accommodation unit 423.

The motor accommodation unit 421 is shaped in such a manner as to possibly accommodate one portion or all portions of the second motor 31. The gear accommodation unit 422 is shaped in such a manner as to possibly accommodate the second motive power transfer apparatus 32. The piston accommodation unit 423 is shaped in such a manner as to be combined with the first housing unit 41 and to possibly form the combination cylinder unit 43.

One end portion (an end portion on the left side of FIG. 3) of the piston accommodation unit 423 that faces the first housing unit 41 is combined with the first housing unit 41, and the piston accommodation unit 423 forms the combination cylinder unit 43. The nut piston 24 is arranged on the other end portion (an end portion on the right side of FIG. 3) of the piston accommodation unit 423 that faces the shoe 5, in a manner that passes through the combination cylinder unit 43 from inside to outside.

FIG. 6 is an operational view illustrating a state where brake is performed by the service brake 2 according to the first embodiment of the present disclosure. FIG. 7 is an operational view illustrating a state where the brake is performed by the parking brake 3 according to the first embodiment of the present disclosure.

With reference to FIG. 6, the service brake 2 according to the first embodiment of the present disclosure performs the operation of pressing against and pushing the shoe 5 by rotating the bolt screw 23 in conjunction with the drive of the first motor 21 and moving toward the axial direction the nut piston 24 combined by the bolt-nut fastening with the circumference of the bolt screw 23.

With reference to FIG. 7, the parking brake 3 according to the first embodiment of the present disclosure is combined by the bolt-nut fastening with the circumference of the nut piston 24 in a manner that overlaps the press nut 33, and performs the operation of preventing the nut piston 24 from being pushed in the opposite direction due to the reaction force of the shoe 5, by moving the press nut 33 toward the axial direction in conjunction with the drive of the second motor 31 and pressing against the press nut 33 toward the axial direction and thus bringing the press nut 33 into contact with the gear assembly portion 231 of the bolt screw 23.

In an initial state as illustrated in FIG. 3, where the first motor 21 is driven in the forward direction, the nut piston 24, as illustrated in FIG. 6, is moved to the right, and pushes a right-side shoe 5 of a pair of the shoes 5 to the right and presses against the shoe 5 on the right. With this operation, the service braking is performed. At this time, the press nut 33 and the gear assembly portion 231 of the bolt screw 23 are spaced away from each other in the axial direction.

Subsequently, when the second motor 31 is driven in the forward direction, the press nut 33, as illustrated in FIG. 7, is moved toward the gear assembly portion 231 and the press contact portion 235 of the bolt screw 23 and comes into contact with each other. At this point, in a state where a first-side portion of the press nut 33 is bound to the nut piston 24, a second-side portion thereof is brought into contact with the bolt screw 23 toward the axial direction, and thus the braking for parking is performed. Subsequently, although the second motor 31 stops being driven, this parking brake state is maintained due to the self-locking structure.

As illustrated in FIG. 6, in a state where the press nut 33 is not brought into contact with the bolt screw 23, when the first motor 21 stops being driven, that is, when only service braking is performed instead of the braking for parking, the nut piston 24 is pushed by itself due to the reaction force of the shoe 5, and the bolt screw 23 is rotated in the reverse direction and, as illustrated in FIG. 3, returns to an initial state thereof.

In a case where the braking for parking is canceled, the following process may be continuously performed. The first motor 21 is driven in the forward direction. Thus, the nut piston 24 is farther pushed toward the shoe 5, and the press nut 33 is spaced away from the press contact portion 235 of the bolt screw 23. Thereafter, the second motor 31 is driven in the reverse direction. By performing this operation of canceling the braking for parking, the bolt screw 23, the nut piston 24, and the press nut 33 may be returned to initial states thereof, respectively, as illustrated in FIG. 3.

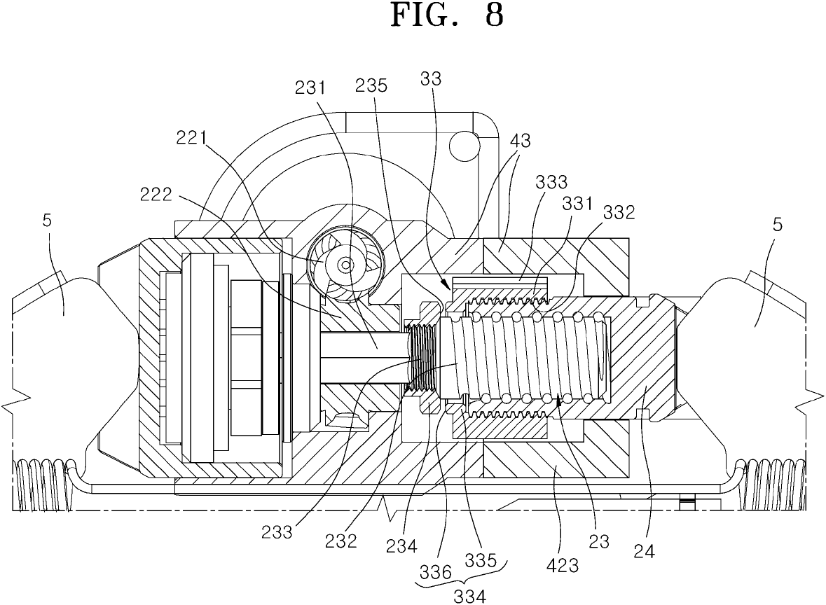

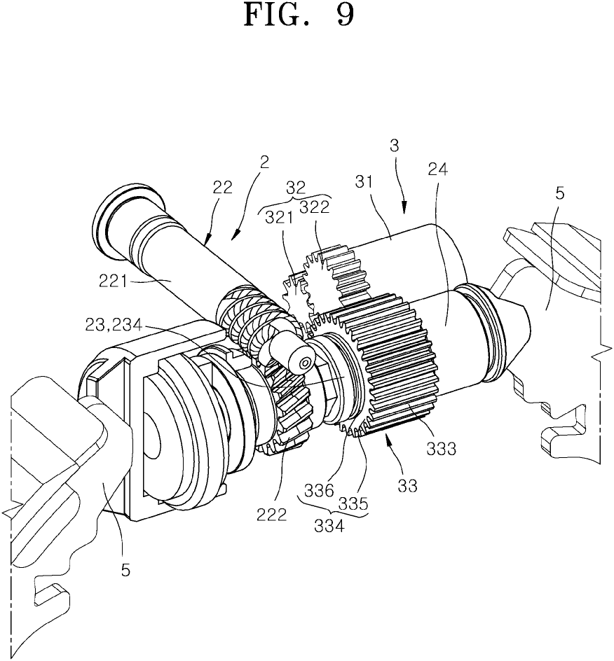

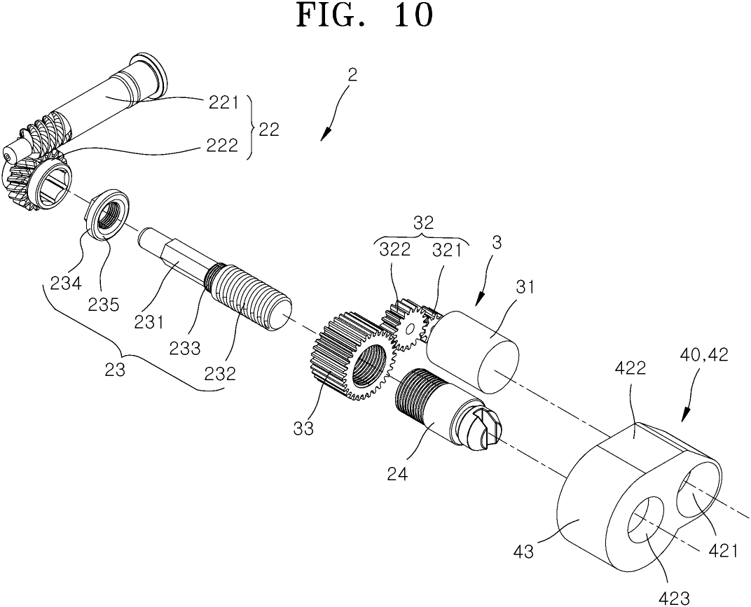

FIG. 8 is a cross-sectional view schematically illustrating essential constituent elements of a drum brake 1 according to a second embodiment of the present disclosure. FIG. 9 is a perspective view schematically illustrating the essential constituent elements of the drum brake 1 according to the second embodiment of the present disclosure. FIG. 10 is an exploded perspective view schematically illustrating the essential constituent elements of the drum brake 1 according to the second embodiment of the present disclosure.

With reference to FIGS. 8 to 10, the drum brake 1 according to the second embodiment of the present disclosure is different from the drum brake 1 according to the first embodiment of the present disclosure, illustrated in FIGS. 1 to 7, in that in the drum brake 1 according to the second embodiment, the gear assembly portion 231 of the bolt screw 23 has a smaller diameter than the screw extension portion 232 and that the bolt screw 23 further includes a fixation portion 233 and a press plate 234.

Constituent elements of the drum brake 1 according to the second embodiment of the present disclosure that are the same as, are similar to, or correspond to, those of the drum brake 1 according to the first embodiment of the present disclosure, which are illustrated in FIGS. 1 to 7, are not repeatedly described below.

With reference to FIGS. 8 to 10, the bolt screw 23 according to the second embodiment of the present disclosure includes the gear assembly portion 231, the screw extension portion 232, the fixation portion 233, the press plate 234, and the press contact portion 235.

The gear assembly portion 231 is a portion of the bolt screw 23 that is supplied with a rotational force from the first motor 21 through the first motive power transfer apparatus 22. The gear assembly portion 231 is installed in a manner that passes through the screw combination hole 223 in the driven gear 222 toward the axial direction and has a cross section with a fixed shape with respect to the axial direction. Accordingly, the bolt screw 23 is slidably movable toward the axial direction in the state of being guided by the edge portion of the screw combination hole 223.

In addition, the gear assembly portion 231 and the screw combination hole 223 each have a cross section having a shape other than a circle, for example, have a polygonal cross section. Accordingly, when the driven gear 222 is driven, the bolt screw 23 may be stably rotated by the same rotational displacement as the driven gear 222.

The screw extension portion 232 is a portion of the bolt screw 23 that is combined by the bolt-nut fastening with the nut piston 24. The screw extension portion 232 is formed on the same axis as the gear assembly portion 231. The circumference of the screw extension portion 232 is externally threaded in such a manner that the nut piston 24 may be combined by the bolt-nut fastening with the screw extension portion 232. The screw extension portion 232 according to the second embodiment of the present disclosure is externally threaded in such a manner as to have a ball-screw structure.

Usually, in a case where, as in the first embodiment of the present disclosure, a circumference of an end portion of a member having the shape of a bar is internally tapped, according to the ease with which the bar-shaped member is machined, a middle portion in the lengthwise direction of the bar-shaped member is pre-machined and then a rear end portion thereof is machined. Accordingly, the end portion that is internally tapped has a relatively smaller diameter than the middle portion. This may be applied to the bolt screw 23 according to the first embodiment of the present disclosure.

However, unlike in the case where the circumference of the end portion of the bar-shaped member is internally tapped, usually, in a case where, as in the second embodiment of the present disclosure, ball-screw is formed on the circumference of the end portion of the bar-shaped member, according to the ease with which the bar-shaped member is machined, the end portion in the lengthwise direction of the bar-shaped member is pre-machined, and then the middle portion thereof is machined. Accordingly, the end portion on which ball-screw is formed has a relatively greater diameter than the middle portion. This may be applied to the bolt screw 23 according to the second embodiment of the present disclosure.

The externally threaded screw extension portion 232 of the bolt screw 23 according to the first embodiment of the present disclosure has the tap-screw structure. In contrast, the screw extension portion 232 of the bolt screw 23 according to the second embodiment of the present disclosure has the ball-screw structure. In this manner, the bolt screw 23 according to the present disclosure may have a diameter and a cross section, each of which varies with a position in a lengthwise direction, considering various conditions, such as machining conditions, component specifications, and a layout relationship between the bolt screw 23 and each of the adjacent other components.

The fixation portion 233 is a portion of the bolt screw 23 to which the press plate 234 is fixed. The fixation portion 233 is formed between the gear assembly portion 231 and the screw extension portion 232 and is formed in a manner that is coaxially continuous with the gear assembly portion 231 and the screw extension portion 232. The fixation portion 233 according to the second embodiment of the present disclosure has a smaller diameter than the screw extension portion 232 and has a greater diameter than the gear assembly portion 231.

Accordingly, the press plate 234 having the shape of a ring may pass through a circumference of the gear assembly portion 231 and may be smoothly moved up to the fixation portion 233. In a state where the press plate 234 reaches the fixation portion 233, the press plate 234 is trapped on a border between the fixation portion 233 and the screw extension portion 232 that constitutes a stepped jaw, and thus, the press plate 234 is reliably prevented from being moved toward the screw extension portion 232. Thus, the press plate 234 may be firmly held at a setting position where the press plate 234 is brought into contact with the screw extension portion 232.

The press plate 234 is fixed to the fixation portion 233 and is arranged in such a manner as to protrude farther toward the radial direction than the screw extension portion 232. Accordingly, a right-side lateral-surface portion of the press plate 234 that is brought into contact with or faces the screw extension portion 232 has the shape of a hooking jaw.

The press plate 234 is arranged in such a manner that the right-side lateral-surface portion thereof faces the lateral-surface portion of the left side of the press nut 33 combined by the bolt-nut fastening with the circumference of the nut piston 24, in the axial direction, and when the press nut 33 is moved to the left, the right-side lateral-surface portion thereof is pressed against and brought into contact with the press nut 33. That is, the right-side lateral-surface portion of the press plate 234 that is shaped in such a manner as to protrude farther toward the radial direction than the screw extension portion 232 is the press contact portion 235 to which the press nut 33 is removably attached.

The press plate 234 according to the second embodiment of the present disclosure has the shape of a ring. A portion of the right side of the press plate 234 that faces the screw extension portion 232 may have a greater diameter than a portion of the left side thereof. An end portion of the left side thereof may have a polygonal cross section, considering that the end portion of the left side thereof is to be engaged with a tool. This shape is disclosed as a desired example of the press plate 234 according to the present disclosure and is not intended to impose any limitation on the press plate 234.

Any press plate 234 that can form the hooking jaw in this manner may have various shapes that include the shape of a ring and may be arranged on the fixation portion 233. The press plate 234 may be fixed on the fixation portion 233 using various methods, such as the bolt-nut fastening, pressing-fixing (plastic deforming), and key inserting.

In terms of structure, an inner circumference portion of the press plate 234 according to the second embodiment of the present disclosure is internally tapped, and is fixed by the bolt-nut fastening to the externally threaded fixation portion 233. In a state where, in this manner, the press plate 234 is fixed by the bolt-nut fastening to the fixation portion 233, the press plate 234 is pressed against toward the fixation portion 233 and is plastically deformed. Thus, for example, an internally tapped portion of the press plate 234 may be pressed against an externally threaded portion of the fixation portion 233 so forcefully that they may be crushed and permanently prevented from being separated from each other.

The press contact portion 235 is formed on an end portion of the right side of the press plate 234 that faces the press nut 33 in the axial direction. As the press nut 33 is moved toward the axial direction, the press contact portion 235 is brought into contact with or is spaced away from an end portion of the left side of the press nut 33. More specifically, the press contact portion 235 may be formed in the shape of a ring in such a manner as to have a width in the radial direction that corresponds to a difference in diameter between the press plate 234 and the screw extension portion 232.

The screw contact portion 336 has a ring-shaped cross section in such a manner as to face the press contact portion 235. Accordingly, when the press nut 33 is moved to the left, with the screw contact portion 336, the press nut 33 is precisely pressed against and brought into contact with the press contact portion 235. Motive power that is transferred from the second motor 31 to the press nut 33 finally serves as a load that is exerted on the press contact portion 235 of the bolt screw 23 toward the axial direction through the screw contact portion 336.

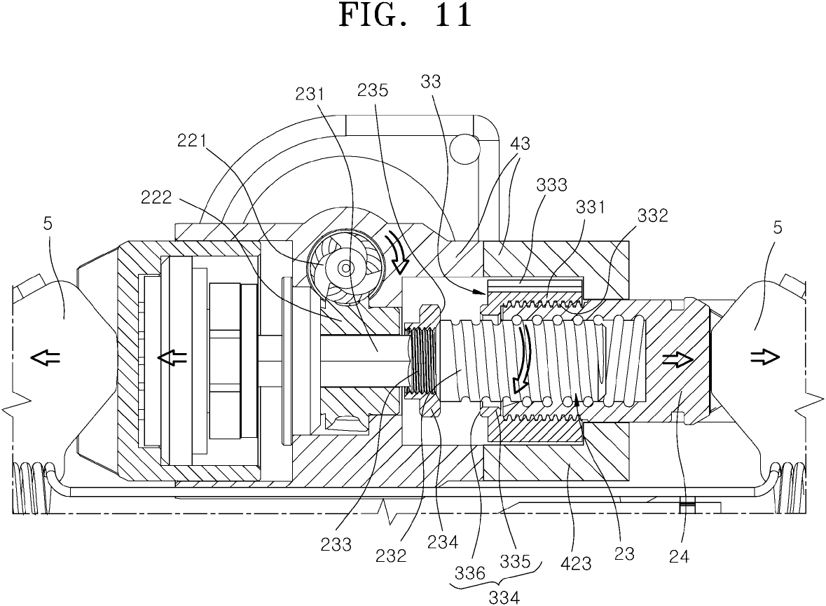

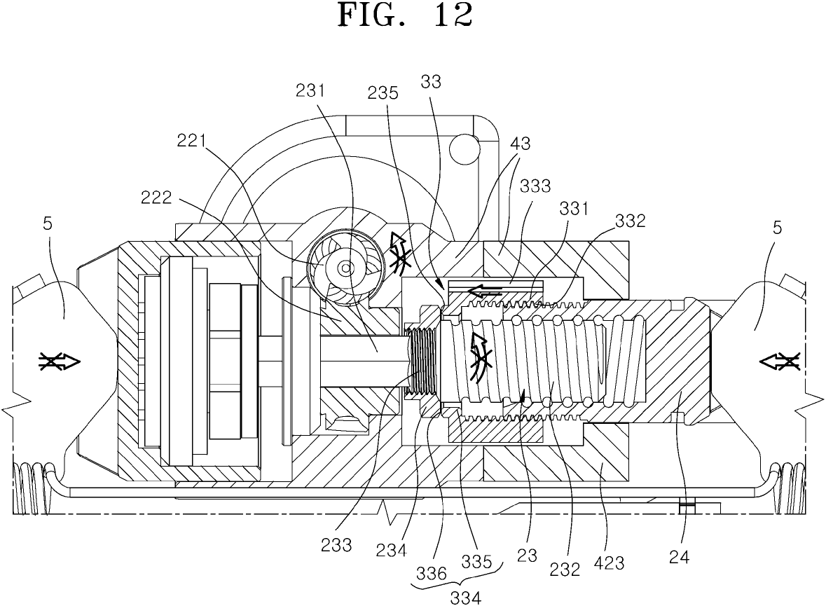

FIG. 11 is an operational view illustrating a state where the brake is performed by the service brake 2 according to the second embodiment of the present disclosure. FIG. 12 is an operational view illustrating a state where the brake is performed by the parking brake 3 according to the second embodiment of the present disclosure.

With reference to FIG. 11, the service brake 2 according to the second embodiment of the present disclosure performs the operation of pressing against and pushing the shoe 5 by rotating the bolt screw 23 in conjunction with the drive of the first motor 21 and moving toward the axial direction the nut piston 24 combined by the bolt-nut fastening with the circumference of the bolt screw 23.

With reference to FIG. 12, the parking brake 3 according to the first embodiment of the present disclosure is combined by the bolt-nut fastening with the circumference of the nut piston 24 in a manner that overlaps the press nut 33, and performs the operation of preventing the nut piston 24 from being pushed in the opposite direction due to the reaction force of the shoe 5, by moving the press nut 33 toward the axial direction in conjunction with the drive of the second motor 31 and pressing against the press nut 33 toward the axial direction and thus bringing the press nut 33 into contact with the press plate 234 of the bolt screw 23.

In the initial state as illustrated in FIG. 8, when the first motor 21 is driven in the forward direction, the nut piston 24, as illustrated in FIG. 11, is moved to the right, and pushes the right-side shoe 5 of the pair of the shoes 5 to the right and presses against the shoe 5 on the right. With this operation, the service braking is performed. At this point, the press nut 33 and the press plate 234 of the bolt screw 23 are spaced away from each other in the axial direction.

Subsequently, when the second motor 31 is driven in the forward direction, the press nut 33, as illustrated in FIG. 12, is moved toward the press plate 234 and the press contact portion 235 of the bolt screw 23 and comes into contact with each other. At this point, in the state where a first-side portion of the press nut 33 is bound to the nut piston 24, a second-side portion thereof is brought into contact with the bolt screw 23 toward the axial direction, and thus the braking for parking is performed. Subsequently, although the second motor 31 stops being driven, this parking brake state is maintained due to the self-locking structure.

As illustrated in FIG. 11, in the state where the press nut 33 is not brought into contact with the bolt screw 23, when the first motor 21 stops being driven, that is, when only the service braking is performed instead of the braking for parking, the nut piston 24 is pushed by itself due to the reaction force of the shoe 5, and the bolt screw 23 is rotated in the reverse direction and, as illustrated in FIG. 8, returns to the initial state thereof.

In the case where the braking for parking is canceled, the following process may be continuously performed. The first motor 21 is driven in the forward direction. Thus, the nut piston 24 is farther pushed toward the shoe 5, and the press nut 33 is spaced away from the press contact portion 235 of the bolt screw 23. Thereafter, the second motor 31 is driven in the reverse direction. By performing this operation of canceling the braking for parking, the bolt screw 23, the nut piston 24, and the press nut 33 may be returned to the initial states thereof, respectively, as illustrated in FIG. 8.

The drum brake 1 according to the present disclosure has a structure in which the service brake 2 and the parking brake 3 are coaxially combined with each other. More specifically, according to the present disclosure, the drum brake 1 has a structure in which the bolt screw 23 and the nut piston 24 of the service brake 2 and the press nut 33 of the parking brake 3 are coaxially combined by the bolt-nut fastening with each other. In other words, the parking brake 3 according to the present disclosure has a simple structure in which the press nut 33 is additionally combined by the bolt-nut fastening with the circumference of the nut piston 24 provided in the service brake 2. That is, according to the present disclosure, the drum brake 1 has a simple structure in which the service brake 2 and the parking brake 3 share one screw corresponding to the bolt screw 23.

Accordingly, the above-mentioned structures according to the present disclosure provide the following advantages, when compared with the case where the service brake 2 and the parking brake 3 in the related art are arranged independently of each other, in other words, when compared with the case where the service brake 2 and the parking brake 3 in the related art are arranged in such a manner as to be spaced away from each other and thus to be separated from each other. The numbers of components of, and volumetric weights, of the service brake 2 and the parking brake 3 can be remarkably reduced, and space utilization and the freedom of layout design can be further improved. Moreover, the manufacturing cost and the productivity can be improved.

In addition, according to the present disclosure, when the press nut 33 is brought into contact with the press contact portion 235 only by exerting a load high enough to restrict the rotation of the nut piston 24, the braking for parking may be performed. Accordingly, when compared with the parking brake 3 in the related art in which the shoe 5 is directly pressed against, the braking for parking can be stably performed by outputting a remarkably low load. Therefore, the motor corresponding to the second motor 31, the power transmission device corresponding to the second power transmission device 32, and the housing covering them can be reduced in size and weight.

The embodiments of the present disclosure are mostly described above. It would be understandable to a person of ordinary skill in the art to which the present disclosure pertains that the present disclosure may be practiced in modified forms within the scope that does not depart from the nature and gist of the present disclosure. Therefore, the embodiments disclosed should be considered in a explanative point of view, not in a limited point of view. The scope of the present disclosure is defined in the claims, not in the specification, and all equivalent differences should be interpreted as falling within the scope of the present disclosure.

What is claimed is:

1. A drum brake comprising:
a bolt screw being configured to be rotatable in conjunction with drive of a first motor;
a nut piston being combined by a bolt-nut fastening with a circumference of the bolt screw and being configured to be movable toward a direction in which the nut piston presses against a shoe, in conjunction of the rotation of the bolt screw; and
a press nut being combined by the bolt-nut fastening with a circumference of the nut piston, being configured to be movable toward an axial direction in conjunction with drive of a second motor, and being configured to be brought into contact with the bolt screw to prevent the nut piston from being pushed due to a reaction force of the shoe.

2. The drum brake of claim 1, wherein the first motor, the bolt screw, and the nut piston are components of a service brake for reducing a traveling speed of a vehicle or for suddenly stopping the vehicle,
wherein the second motor and the press nut are components of a parking brake for parking the vehicle or for keeping the vehicle at a stop, and
wherein the press nut and the bolt screw are spaced in the axial direction away from each other in a state where the nut piston presses against the shoe due to the drive of the first motor, and the press nut is configured to be movable toward the bolt screw due to the drive of the second motor to be into contact with the bolt screw.

3. The drum brake of claim 1, wherein an inner circumferential portion of the nut piston and an outer circumferential portion of the bolt screw have a screw structure in which, in a state where the nut piston presses against the shoe, when the first motor stops being driven, the nut piston is not self-locked in response to the reaction force of the shoe, and
wherein an inner circumferential portion of the press nut and an outer circumferential portion of the nut piston have a screw structure in which, in a state where the press nut is brought into contact with the bolt screw toward the axial direction, when the second motor stops being driven, the nut piston is self-locked in response to the reaction force of the shoe.

4. The drum brake of claim 1, wherein the first motor, the bolt screw, and the nut piston are components of a service brake for reducing a traveling speed of a vehicle or for suddenly stopping the vehicle,
wherein the service brake further comprises:
a first motive power transfer apparatus transferring a rotational force of the first motor to the bolt screw,
wherein the first motive power transfer apparatus comprises:
a drive gear being supplied with motive power from the first motor, thereby being rotated; and
a driven gear being engaged with the drive gear, thereby being rotated at a reduced speed, and being coaxially combined with the bolt screw.

5. The drum brake of claim 4, wherein the bolt screw comprises:
a gear assembly portion having a polygonal cross section, being installed in a manner that passes through a screw combination hole in the driven gear, and being configured to be slidably movable along the screw combination hole toward the axial direction; and
a screw extension portion being coaxially continuous with the gear assembly portion and being combined by the bolt-nut fastening with the nut piston.

6. The drum brake of claim 1, wherein the bolt screw comprises:
a gear assembly portion being supplied with a rotational force from the first motor;
a screw extension portion being coaxially continuous with the gear assembly portion and being combined by the bolt-nut fastening with the nut piston; and
a press contact portion being arranged on the gear assembly portion or the screw extension portion in a manner that faces the press nut in the axial direction, and being brought int contact with the press nut.

7. The drum brake of claim 6, wherein the screw extension portion has a smaller diameter than the gear assembly portion, and
wherein the press nut is arranged in a manner that faces a first-side lateral-surface portion in the axial direction of the gear assembly portion.

8. The drum brake of claim 1, wherein the bolt screw comprises:
a gear assembly portion being supplied with a rotational force from the first motor;
a screw extension portion being combined by the bolt-nut fastening with the nut piston;
a fixation portion being disposed between the gear assembly portion and the screw extension portion and being coaxially continuous with the gear assembly portion and the screw extension portion;
a press plate being fixed to the fixation portion and being arranged in a manner that protrudes farther toward a radial direction than the screw extension portion; and
a press contact portion being arranged on the press plate in a manner that faces the press nut in the axial direction and being brought into contract with the press nut.

9. The drum brake of claim 8, wherein the gear assembly portion has a smaller diameter than the screw extension portion, and
wherein the press nut is arranged in a manner that faces a first-side lateral-surface portion in the axial direction of the press plate.

10. The drum brake of claim 8, wherein the fixation portion is externally threaded, and
wherein the press plate is fixed by combining an internally-tapped ring member with the fixation portion by the bolt-nut fastening.

11. The drum brake of claim 1, wherein the second motor and the press nut are components of a parking brake for parking a vehicle or for keeping the vehicle at a stop,
wherein the parking brake further comprises:
a second motive power transfer apparatus transferring a rotational force of the second motor to the press nut, and
wherein the second motive power transfer apparatus comprises:
a first gear being connected to the second motor; and
a second gear of which a first-side portion is engaged with the first gear to be rotatable at a reduced speed and of which a second-side portion is engaged with the press nut.

12. The drum brake of claim 11, wherein the press nut that has a greater diameter than the second gear, is engaged with the second gear and has such a length in the axial direction that the press nut is movable in a manner that is brought into contact with or spaced from the bolt screw, while kept engaged with the second gear.

13. The drum brake of claim 1, further comprising:
a housing having one communicating space in which the bolt screw, the nut piston, and the press nut are accommodated,
wherein the housing comprises:
a first housing unit in which one portion of a service brake is accommodated;
a second housing unit in which one portion of a parking brake is accommodated; and
a combination cylinder unit having a shape of a hollow cylinder in a portion where the first housing unit and the second housing unit are combined with each other, and accommodating the bolt screw, the nut piston, and the press nut.

14. The drum brake of claim 13, wherein the second housing unit comprises:
a motor accommodation unit accommodating the second motor;
a gear accommodation unit accommodating a second motive power transfer apparatus transferring a rotational force of the second motor to the press nut; and
a piston accommodation unit whose one end portion facing the first housing unit is combined with the first housing unit, thereby forming the combination cylinder unit, and on whose other portion facing the shoe the nut piston is installed by passing therethrough, the piston accommodation unit being configured to communicate with the gear accommodation unit.

15. An electronic parking brake comprising:
a second motor;
a press nut being combined by a bolt-nut fastening with a circumference of a nut piston of a service brake that presses against a shoe, being configured to be movable toward an axial direction in conjunction with drive of the second motor, and being configured to be brought into contact with a bolt screw combined by the bolt-nut fastening with the nut piston to prevent the nut piston from being pushed due to a reaction force of the shoe; and
a second motive power transfer apparatus transferring a rotational force of the second motor to the press nut.

16. The electronic parking brake of claim 15, wherein the press nut comprises:
a nut main body being arranged on a circumference of the nut piston;
a screw combination portion being disposed on an inner circumferential portion of the nut main body and being combined by the bolt-nut fastening with the nut piston;
a gear-teeth portion being formed on an outer circumferential portion of the nut main body and being supplied with the rotational force from the second motor; and
a screw attachment-detachment portion being disposed on an end portion of the nut main body and being configured to be brought into contact with the bolt screw toward the axial direction when the nut main body is moved.

17. The electronic parking brake of claim 16, wherein the screw attachment-detachment portion comprises:
a limitation jaw being disposed on an end portion in the axial direction of the nut main body in a manner that protrudes inward toward a direction of an axial center, and being arranged in a manner that faces the nut piston positioned inside the nut main body, in the axial direction; and
a screw contact portion being disposed on the limitation jaw in a manner that protrudes toward the axial direction, and facing the bolt screw in the axial direction and being in contact therewith.

18. The electronic parking brake of claim 17, wherein inner circumferential portions of the limitation jaw and the screw contact portion each have a greater diameter than the bolt screw and are spaced away from a circumference of the bolt screw, and
wherein motive power that is transferred from the second motor to the nut main body serves as a load that is exerted on the bolt screw toward the axial direction through the screw contact portion.

19. The electronic parking brake of claim 17, wherein, when the second motor is driven in a forward direction, the press nut is movable to one side toward the axial direction up to a position where the screw contact portion is pressed against and brought into contact with the bolt screw toward the axial direction, and
wherein when the second motor is driven in a reverse direction, the press nut is movable to the other side toward the axial direction up to a position where the limitation jaw is brought into contact with the nut piston toward the axial direction.

20. The electronic parking brake of claim 15, wherein at least one portion of the second motor is accommodated together in a housing in which the bolt screw, the nut piston, and the press nut are accommodated, and is arranged on one side of a plate surface of a backplate in a manner that is in parallel with the bolt screw, the nut piston, and the press nut.
